(19) United States
(12) Patent Application Publication
(10) Pub. No.: US 2014/0212072 A1
(43) Pub. Date: Jul. 31, 2014

(54) CANINE WASTE CONTAINMENT SYSTEM

(71) Applicant: PACK **IT OUT, Denver, CO (US)

(72) Inventor: Lisa Mackey, Denver, CO (US)

(73) Assignee: PACK **IT OUT, Denver, CO (US)

(21) Appl. No.: 14/168,489

(22) Filed: Jan. 30, 2014

Related U.S. Application Data
(60) Provisional application No. 61/758,953, filed on Jan. 31, 2013.

(51) Int. Cl. A01K 23/00

(52) U.S. Cl. CPC A01K 23/005
USPC 383/38

(57) ABSTRACT

A canine waste containment system includes one or more pockets and a pouch with a liner. In embodiments, the canine waste containment system may be attached to a harness, collar, or leash via one or more retainer straps and worn on the back of the canine.

### BACKGROUND

Containment of canine waste is becoming a widespread problem in residential and wilderness areas alike. Typically, a canine owner will collect canine waste in a plastic bag. Often, however, when a trash receptacle is not located nearby, the canine owner may leave the plastic bag filled with the canine waste on the ground to be retrieved later, or not at all. These plastic bags not only create an eyesore, but are also a health hazard to people, other canines, and wildlife.

### SUMMARY

Embodiments of the present application are directed at a waste containment system. The waste containment system comprises a top side which further comprises at least one top pocket and a pouch. The pouch further comprises liner. The waste containment system comprises a bottom side. The bottom side further comprises at least one bottom pocket, at least one retainer strap and an expanding bellows connecting the top side and the bottom side.

### BRIEF DESCRIPTION OF FIGURES

There are shown in the Figures certain embodiments, it being understood, however, that the technology is not limited to the precise arrangements and instrumentalities shown.

FIG. 1 is a top view of a canine waste containment system.

FIG. 2 is side view of the canine waste containment system of FIG. 1.

FIG. 3 is bottom view of the canine waste containment system of FIG. 1.

FIG. 4 is a top cut-away view of the canine waste containment system of FIG. 1 depicting a lining.

FIG. 5 is a bottom view of the canine waste containment system of FIG. 1 with a back flap lifted.

### DETAILED DESCRIPTION OF THE FIGURES

The present application describes embodiments of the canine waste containment system. In embodiments, the canine waste containment system includes an outer lining, one or more pockets, and a pouch with a liner. The liner material may be selected as required or desired for a particular application. The one or more pockets may store plastic bags for containing canine waste. A plastic bag containing canine waste may be placed within the pouch's interior liner. The liner performs various functions depending on the type of material utilized, as described in more detail below. In one embodiment, the liner wicks moisture such that, if canine waste leaks, it is absorbed by the liner of the canine waste containment system. In embodiments, the canine waste containment system may be attached to a harness, leash, or collar via one or more retainer straps and worn on the back of the canine By securing the canine waste containment system to the harness, sliding or other movement is reduced or eliminated. In other embodiments, the canine waste containment system may be attached to a belt loop of the owner, or may be carried by hand. Embodiments of the canine waste containment system, as depicted by the figures, will be discussed in further detail below.

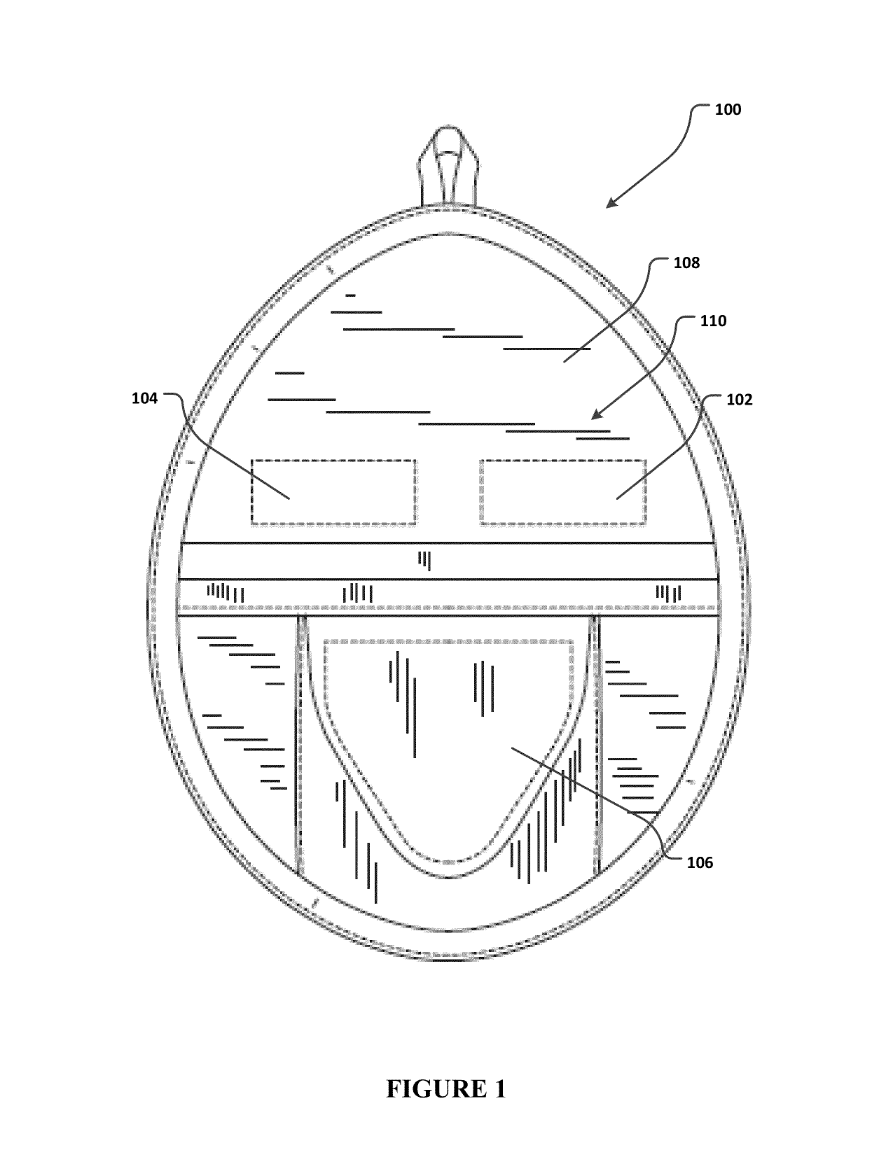

FIG. 1 is a top view of a canine waste containment system 100. The canine waste containment system 100 may be constructed of any fabric, including but not limited to nylon canvas, mesh, poly etc. The canine waste containment system may include one or more pockets 102, 104, 106 on a top side 110 thereof. In one embodiment, the pocket 102, 104, 106 is large enough to contain a roll of plastic bags. In another embodiment, the pocket 102,104, 106 may be only large enough to contain an individual plastic bag. The pockets 102, 104, 106 may be secured by any closure known in the art, including but not limited to zippers, buttons, hook and loop fasteners (i.e., VELCRO®), magnets, etc. The pockets 102, 104, 106 of the canine waste containment system may be configured such that, when closed, a plastic bag protruding therefrom may still be pulled out.

The canine waste containment system 100 may also include a pouch 108. Like the one or more pockets 102, 104, 106, the pouch 108 can also be secured by any means known in the art, including but not limited to zippers, buttons, hook and loop fasteners (i.e., VELCRO®), magnets, etc. The pouch 108 may be double layered, so that it is made of twice the amount of material as the one or more pockets 102, 104, 106. Multiple layers of fabric provide additional robustness. The pouch 108 may be lined with a liner material, various types of which are described below. In one embodiment, the liner is partially attached to the interior of the pouch around the perimeter of the pouch opening. By only partially attaching the liner, the liner can be pulled out of the pouch and rinsed. In another embodiment, the lining is removable from the interior of the pouch. The lining may be secured to the interior of the pouch with zippers, buttons, hook and loop fasteners (i.e. VELCRO®), magnets, stitching, etc. The liner may be manufactured with an odor neutralizer, such as charcoal, baking soda, etc. Additionally, the liner may include a desiccant material, to absorb moisture.

When canine waste needs to be contained, a plastic bag may be removed from one of the pockets 102, 104, 106. The plastic bag may be used to pick up the canine waste, and the used plastic bag may be placed inside the pouch 108 until a receptacle is located. The lining may be removed and rinsed or washed. Alternatively, or additionally, the entire canine waste containment system may be washed.

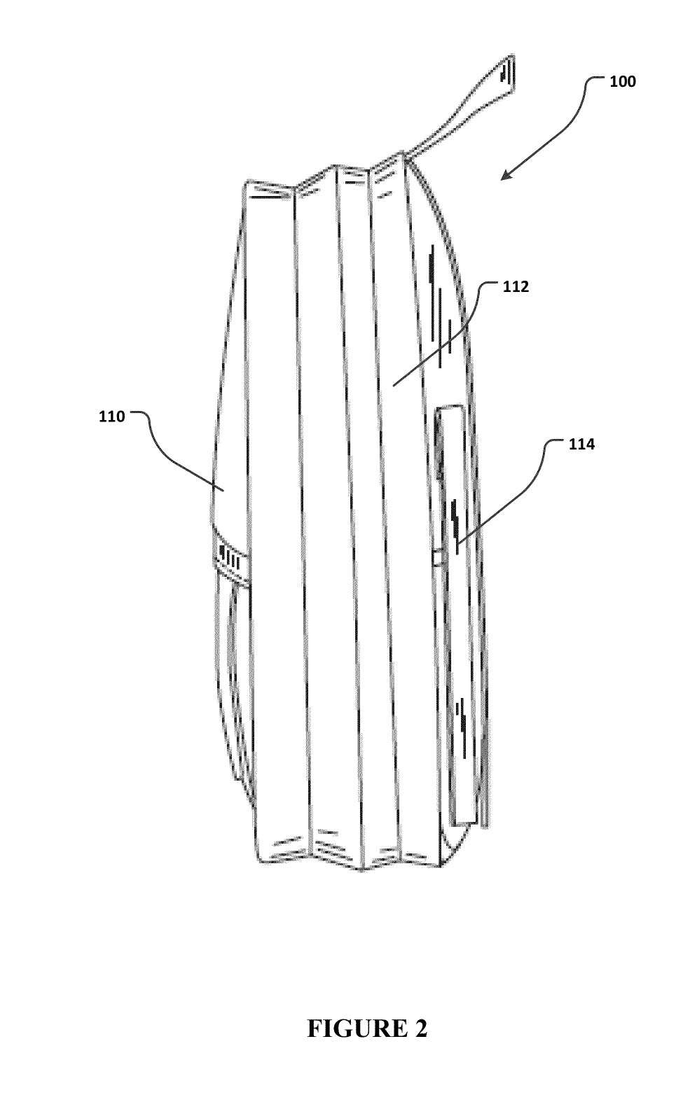

FIG. 2 is side view of the canine waste containment system 100. In embodiments, the canine waste containment system 100 utilizes expanding bellows 112 to accommodate significant volumes of waste. The canine waste containment system 100 may remain collapsed until expansion is needed.

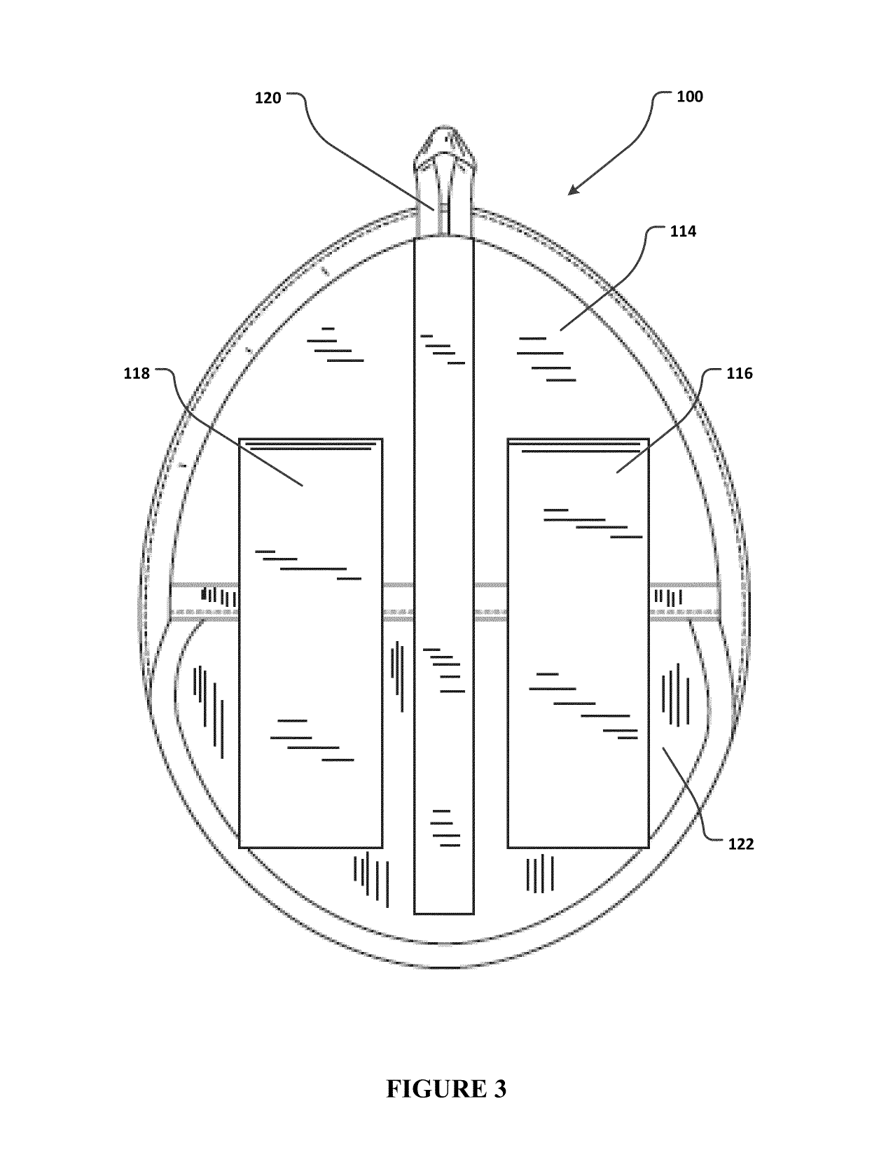

FIG. 3 is bottom view of the canine waste containment system 100 bottom side 114. The canine waste containment system 100 may include one or more retainer straps, such as a right 116 and a left 118 retainer strap located on the bottom side 114 of the canine waste containment system 100. The retainer straps 116, 118 are disposed so as to secure the canine waste containment system 100 to a canine's harness, collar, or leash. The retainer straps 116, 118 may comprise any securement mechanism known in the art, including but not limited to buttons, string, straps, elastic, hook and loop fasteners (i.e., VELCRO®), magnets, etc. In one embodiment, the retainer straps 116, 118 may be removed and repositioned to accommodate different sized canines

The canine waste containment system 100 may also include an upper strap 120, located towards the top of the canine waste containment system 100. In embodiments, this upper retainer strap 120 may be secured to a canine's collar. The upper retainer strap 120 helps the canine waste containment system 100 to remain centrally located over the canine's back and prevents sliding. By securing the canine waste containment system 100 in this manner, the canine is free to play, run, etc., without being disturbed. In other embodiments, this upper retainer strap 120 may be secured to an owner's belt loop, backpack, purse, etc., when the containment system 100 is not in use.

The underside of the canine waste containment system may also include an additional pocket 122. This pocket 122 may be used for additional storage of other items, such as keys, dog treats, etc.

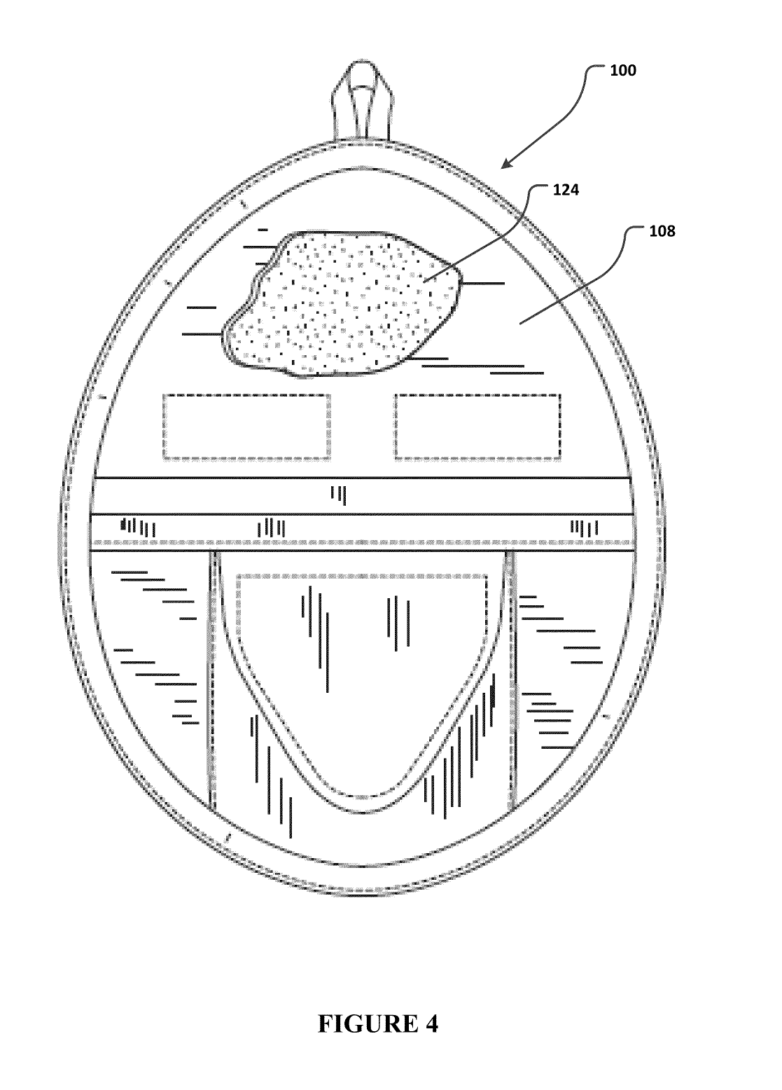

FIG. 4 is a top cut-away view of the canine waste containment system 100 depicting an inner liner 124. The liner 124 may be attached to the interior perimeter of the large pouch 108, allowing removal if desired. The liner 124 may be partially or fully removed, as described herein. The liner 124 may be comprised of any number of materials. In one embodiment, the liner is comprised of a hydrophilic material. The hydrophilic material may be any material that absorbs moisture, such as cotton, wool, etc. A hydrophilic material may be used to absorb any moisture that leaks from a plastic bag placed in the pouch 108.

In another embodiment, the liner 124 is comprised of a hydrophobic material. The hydrophobic material may include plastic, coated fabrics, rubber, or any other material that resists moisture. The hydrophobic material may be used so that moisture from the waste or waste bag is not absorbed by the fabric of the canine waste containment system 100. In another embodiment, the liner 124 is comprised of a vapor transfer material.

In another embodiment the liner 124 is discrete from the fabric allowing the liner to be removed and cleaned. In yet another embodiment, the liner is integral with the fabric. In another embodiment, the liner 124 comprises a hydrophilic inner layer and a hydrophobic outer layer, such at any leaked moisture remains in the pouch and does not leak to the remainder of the waste containment system 100, but is still absorbed by the liner 124. In yet another embodiment, the liner 124 is disposable and replaceable.

In another embodiment, the liner 124 is finished with an antimicrobial. An antimicrobial finish inhibits bacterial growth and reduces odor, which positively affects the sanitization of the liner 124.

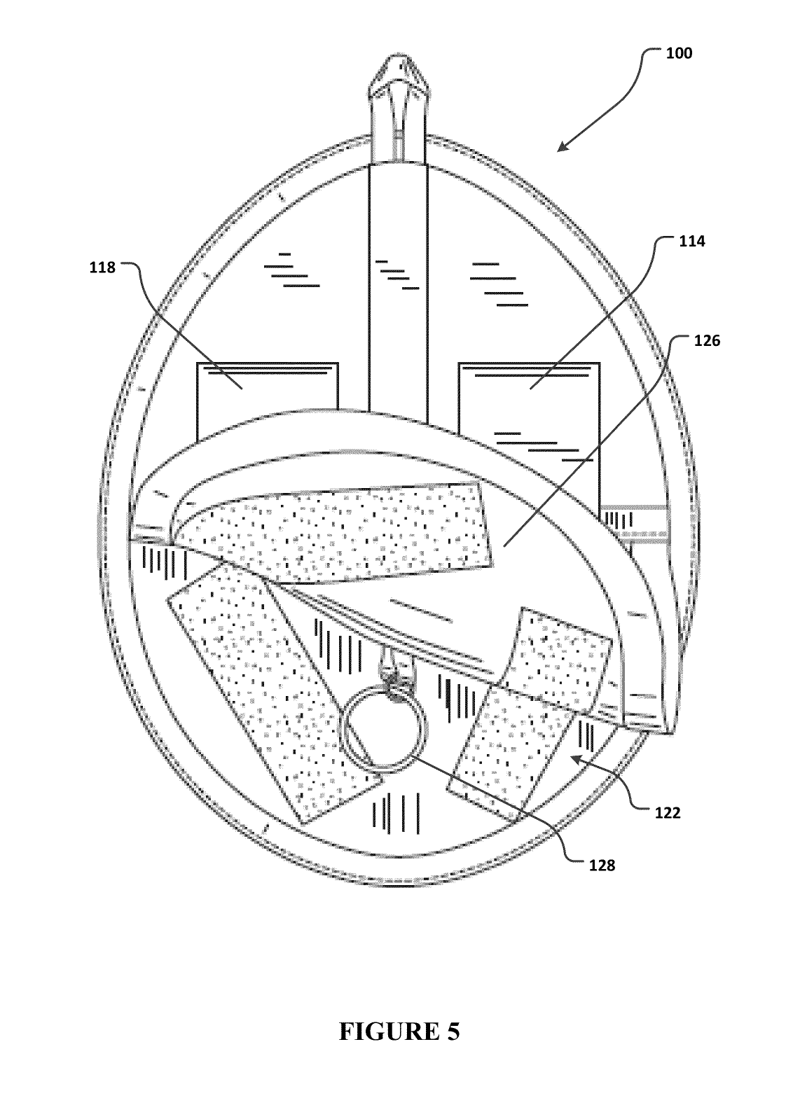

FIG. 5 is a bottom view of the canine waste containment system 100 with a back flap 126 of the rear pocket 122 lifted. The back flap 126 may secure the pocket 122 on the underside of the canine waste containment system with buttons, elastic, hook and loop fasteners (i.e., VELCRO®), magnets, etc. This pocket 108 may be used for additional storage of other items, such as keys, dog treats, etc. In one embodiment, the pocket includes key ring 128.

Although the waste containment system is described herein in the context of canine waste, it should be apparent that the system may be used for containing the waste of any other domestic animal or pet, including but not limited to felines, ferrets, micro pigs, rabbits, etc.

I claim:

1. A waste containment system comprising:
a top side, comprising:
at least one top pocket; and
a pouch comprising a liner; and
a bottom side, comprising:
at least one bottom pocket;
at least one retainer strap; and
an expanding bellows connecting the top side and the bottom side.

2. The waste containment system of claim 1, wherein the liner is double-layered.

3. The waste containment system of claim 1, wherein the liner is a hydrophobic material.

4. The waste containment system of claim 1, wherein the liner material comprises at least one of: polyester, poly-lycra, and apilene.

5. The waste containment system of claim 1, wherein the at least one retainer strap is sized to receive a collar.

6. The waste containment system of claim 1, wherein the at least one retainer strap is sized to receive a harness.

7. The waste containment system of claim 1, wherein the bottom side further comprises a back flap securing the at least one bottom pocket.

8. The waste containment system of claim 7, further comprising a key ring disposed within the at least one bottom pocket.

9. The waste containment system of claim 1, wherein the canine waste containment system is comprised of a fabric.

10. The waste containment system of claim 9, wherein the fabric comprises at least one of: nylon, canvas, and mesh.

11. The waste containment system of claim 1, wherein the liner is a hydrophilic material.

12. The waste containment system of claim 9, wherein the liner is discrete from the fabric.

13. The waste containment system of claim 1, wherein the liner comprises a vapor transfer material.

14. The waste containment system of claim 9, wherein the liner is integral with the fabric.

15. The waste containment system of claim 1, wherein the liner comprises a hydrophilic inner layer and a hydrophobic outer layer.

16. The waste containment system of claim 1, wherein the liner is washable.

17. The waste containment system of claim 1, wherein the liner is disposable.

18. The waste containment system of claim 1, wherein the liner is finished with an antimicrobial.
